(19) United States
(12) Patent Application Publication
(10) Pub. No.: US 2026/0167014 A1
(43) Pub. Date: Jun. 18, 2026

(54) DRIVE CONTROL SYSTEM FOR SADDLE RIDING UTILITY VEHICLE

(71) Applicant: Honda Motor Co., Ltd., Tokyo (JP)

(72) Inventor: Shane R. Smith, Zanesfield, OH (US)

(21) Appl. No.: 18/985,789

(22) Filed: Dec. 18, 2024

(51) Int. Cl. B60L 15/20; B62K 23/00

(52) U.S. Cl. CPC B60L 15/20; B62K 23/00

(57) ABSTRACT

A drive control system for a saddle riding utility vehicle includes at least one electric traction motor arranged to be rotated in a first direction and a second direction to move the vehicle in a forward direction and a reverse direction. A first switch and a second switch are to be displaced from a free position to a depressed position to, respectively, activate a forward movement and a reverse movement of the vehicle. A controller activates a walk assist mode of the vehicle in response to displacement of one of the first switch and the second switch to the depressed position and holding the displaced switch at the depressed position for a predetermined duration. The controller controls a power of the at least one electric traction motor to keep a speed of the vehicle below a predefined speed when the walk assist mode is active.

### BACKGROUND

The disclosed subject matter relates to saddle riding utility vehicles. More particularly, the disclosed subject matter relates to a reverse control system for a saddle riding utility vehicle.

Saddle riding vehicles are, generally, difficult to maneuver around garage/parking lot/loading when the engine is off. Additionally, a ramp is typically used to load a saddle riding vehicle on a truck and unload the vehicle from the truck. Manually moving the vehicles on the ramp with engine-off quite is difficult and cumbersome, while moving the vehicles on the ramp with engine on is difficult to control, and is undesirable.

### SUMMARY

In accordance with one embodiment of the present disclosure, a drive control system for a saddle riding utility vehicle is disclosed. The drive control system includes at least one electric traction motor arranged to be rotated in a first direction and a second direction to move the saddle riding utility vehicle in a forward direction and a reverse direction, and a first switch configured to be displaced from a free position to a depressed position to activate a movement of the saddle riding utility vehicle in the forward direction. The drive control system also includes a second switch adapted to be displaced from a free position to a depressed position to activate a movement of the saddle riding utility vehicle in the reverse direction. Further, the drive control system includes a controller communicatively coupled to the first switch, the second switch, and the at least one electric traction motor. The controller is configured to activate a walk assist mode of the saddle riding utility vehicle in response to displacement of one of the first switch and the second switch to the depressed position and holding the displaced switch of the first and second switches at the depressed position for a predetermined duration. The controller is also configured to control a power of the at least one electric traction motor to keep a speed of the saddle riding utility vehicle below a predefined speed when the walk assist mode is active.

In accordance with another embodiment of the present disclosure, a saddle riding utility vehicle is disclosed. The saddle riding utility vehicle includes at least one electric traction motor arranged to be rotated in a first direction and a second direction to move the saddle riding utility vehicle in a forward direction and a reverse direction, and a first switch configured to be displaced from a free position to a depressed position to activate a movement of the saddle riding utility vehicle in the forward direction. Further, the saddle riding utility vehicle includes a second switch adapted to be displaced from a free position to a depressed position to activate a movement of the saddle riding utility vehicle in the reverse direction. Furthermore, the saddle riding utility vehicle includes a controller communicatively coupled to the first switch, the second switch, and the at least one electric traction motor. The controller is configured to activate a walk assist mode of the saddle riding utility vehicle in response to a displacement of one of the first switch and the second switch to the depressed position and holding the displaced switch of the first switch and the second switch at the depressed position for a predetermined duration. The controller is also configured to control a power of the at least one electric traction motor to keep a speed of the saddle riding utility vehicle below a predefined speed when the walk assist mode is active.

In accordance with yet a further embodiment of the present disclosure a saddle riding utility vehicle is disclosed. The saddle riding utility vehicle includes at least one electric traction motor arranged to be rotated in a first direction and a second direction to move the saddle riding utility vehicle in a forward direction and a reverse direction. The saddle riding utility vehicle also includes a first switch configured to be displaced from a free position to a depressed position to activate a movement of the saddle riding utility vehicle in the forward direction, and a second switch adapted to be displaced from a free position to a depressed position to activate a movement of the saddle riding utility vehicle in the reverse direction. Furthermore, the saddle riding utility vehicle includes a controller communicatively coupled to the first switch, the second switch, and the at least one electric traction motor. The controller is configured to activate a walk assist mode of the saddle riding utility vehicle in response to displacement of one of the first switch and the second switch to the depressed position and holding the displaced switch of the first switch and the second switch at the depressed position for a predetermined duration. The controller is also configured to control a power of the at least one electric traction motor to keep a speed of the saddle riding utility vehicle below a predefined speed when the walk assist mode is active. Further, the controller is configured to activate the walk assist mode for movement of the saddle riding utility vehicle in the forward direction when the first switch is displaced to the depressed position and held at the depressed position for the predetermined duration. Moreover, the controller is configured to activate the walk assist mode for movement of the saddle riding utility vehicle in the reverse direction when the second switch is displaced to the depressed position and held at the depressed position for the predetermined duration.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a perspective view of a saddle riding utility vehicle, in accordance with one embodiment of the present disclosure; and

FIG. 2 is a block diagram of the vehicle of FIG. 1 and schematically depicts various components of the vehicle, in accordance with one embodiment of the present disclosure.

### DETAILED DESCRIPTION OF EXEMPLARY EMBODIMENTS

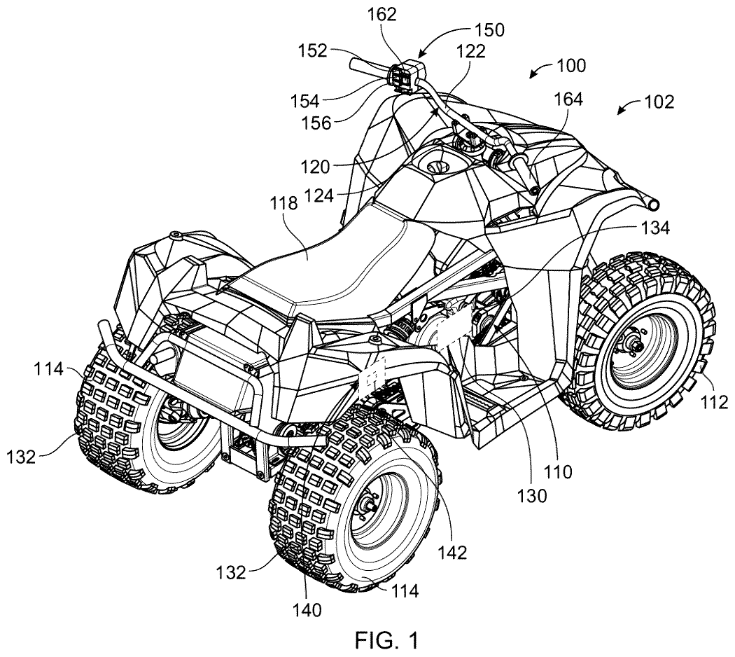

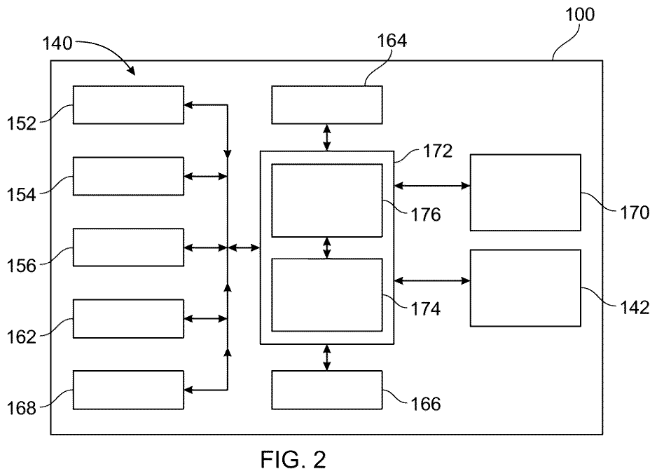

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-2, wherein like numbers indicate the same or corresponding elements throughout the views.

FIG. 1 illustrates a perspective view of a vehicle, indicated generally as 100, in accordance with one embodiment of the present disclosure. As shown, the vehicle 100 is a saddle riding utility vehicle 102. However, it may be envisioned that the vehicle may be a scooter, motorcycle, other type of all-terrain vehicle, or any other similar vehicle known in the art. As depicted in FIG. 1, the vehicle 100 includes a frame 110, a plurality of wheels, for example, a pair of front wheels 112 and a pair of rear wheels 114, coupled to the frame 110 and adapted to rotate to enable a movement of the vehicle 100 over a path, and a seat 118 supported on the frame 110 to facilitate a seating of at least one person, for example, a rider, on the vehicle 100. Further, the vehicle 100 includes a handlebar assembly 120 having a handlebar 122, a steering tube 124, and a pair of suspension forks (not shown) extending downwardly from the steering tube 124 and coupled to the front wheel 112. The steering tube 124 is rotatably coupled to the frame 110, and the handlebar 122 is attached to the steering tube 124 to enable a rotation of the steering tube 124 by a rider to facilitate the steering of the vehicle 100.

Further, the vehicle 100 includes a power source 130 providing motive power to the vehicle 100 to rotate at least one drive wheel 132 of the vehicle 100. In the illustrated embodiment, the at least one drive wheel 132 includes the rear wheels 114 of the vehicle 100, however, the at least one drive wheel 132 may include the front wheels 112 or both the front wheels 112 and the rear wheels 114 of the vehicle 100. Moreover, in the illustrated embodiment, the power source 130 includes at least one electrical energy storage unit 134 to store electrical power and provide electrical power to electrical and electronic components of the vehicle 100. The at least one electrical energy storage unit 134 may include one or more of battery, ultracapacitor, supercapacitor, inductor, or a combination thereof. Also, the electrical energy storage unit 134 may be a rechargeable unit configured to be recharged by using a suitable external power source. Although the electrical energy storage unit 134 is contemplated as the power source 130, it may be appreciated that, in some embodiments, the power source 130 may be an internal combustion engine.

Further, the vehicle 100 includes a drive control system 140 operatively connected to the power source 130 and configured to rotate the at least one drive wheel 132, for example, rear wheels 114. In the embodiment, the drive control system 140 includes at least one electric traction motor 142 adapted to receive electrical energy from the at least one electrical energy storage unit 134 and rotates the rear wheels 114. In the embodiment, the at least one electric traction motor 142 is a bi-directional motor configured to rotate in a first direction and a second direction opposite to the first direction. Accordingly, the at least one electric traction motor rotates the rear wheels 114 in the first direction to move the vehicle 100 in a forward direction and in the second direction to move the vehicle 100 in the reverse direction, i.e., reversing the vehicle 100.

In some embodiments, the at least one electric traction motor 142 may be a unidirectional motor and is configured to rotate in the first direction. In such a scenario, to move the vehicle 100 in the reverse direction, the vehicle 100 may include a transmission arranged between the at least one electric traction motor 142 and the rear wheels 114 and having at least one forward gear and a reverse gear. In some embodiment, the transmission may be a manual transmission, an automatic transmission, or a semi-automatic transmission.

Referring to FIGS. 1 and 2, to enable a user to control the movement of the vehicle 100 and the drive control system 140 includes a switch assembly 150 that may be mounted to the handlebar 122 and arranged proximate to one of the handle grips of the handlebar 122. The switch assembly 150 includes a plurality of switches adapted to be manipulated by a driver of the vehicle 100 to enable the driver of the vehicle 100 to control the drive system 140 of the vehicle 100. For example, the switch assembly 150 includes a first switch 152 to control the drive system 140 to move the vehicle in a forward direction, and a second switch 154 to control the drive system 140 move the vehicle 100 in a reverse direction. In the illustrated embodiment, the first switch 152 and the second switch 154 are spring biased switches in which springs bias the switches 152 to the free position.

Moreover, the switch assembly 150 includes a third switch 156, also referred to as a neutral switch, to disengage the at least one electric traction motor 142 from the rear wheels 114 or prevents the rotation of the at least one electric traction motor 142 and/or the rear wheels 114 even upon actuation of a throttle of the vehicle 100. In some embodiments, the drive system 140 may include a clutch (not shown) arranged between the at least one electric traction motor 142 and the rear wheels 114 to engage and the disengage the at least one electric traction motor 142 and the rear wheels 114. In such a case, the clutch is operated, upon actuation of the third switch 156, to disengage the at least one electric traction motor 142 and the rear wheels 114. Furthermore, the switch assembly 150 includes a fourth switch 162, also referred to as start-stop switch 162, to start and stop at least one electric traction motor 142.

Additionally, the vehicle 100 i.e., the drive control system 140 includes a throttle lever 164, shown in FIGS. 1 and 2, to control the speed of the travel of the vehicle 100 and move the vehicle in a desired direction. Also, the vehicle 100 includes a speed sensor 166, shown in FIG. 2, to detect/monitor a speed of the vehicle 100 in the forward direction and/or the reverse direction.

Also, the vehicle 100 is configured to be operated/moved in a plurality of modes including, but not limited to, a normal mode and a walk assist mode. In the normal mode, the vehicle 100 is configured to be operated at normal power based on at least one normal power map to control the electric traction motor 142 based on a position or displacement of the throttle lever 164 from its free/default position. In the walk assist mode, the vehicle 100 is operated at a reduced power based based on at least one reduced power map to control the electric traction motor 140 at a reduced power to move the vehicle 100 when the rider is walking besides the vehicle 100. In an embodiment, a reduced torque/power is obtained from the electric traction motor 142 in the walk assist mode than the normal mode for same displacement of the throttle lever 164 to keep the speed of the vehicle 100 below a predefined speed. For so doing, in some embodiments, in the walk assist mode, the electric current provided to the electric traction motor 142 is kept below a predefined value to keep the speed of the vehicle 100 i.e., the electric traction motor 142, below the predefined speed. Accordingly, the speed of the vehicle 100 may vary between zero and the predefined speed depending upon the displacement of the throttle lever 164 from its free position when walk assist mode is active. The predefined speed may be a speed that enables the rider to move the vehicle 100 when the rider is walking besides the vehicle 100 holding the handlebar.

In some embodiments, the electric traction motor 152, in the walk assist mode, is controlled such that the vehicle 100 moves at the constant speed, i.e., at the predefined speed irrespective of the displacement of the throttle lever 164 from its free position. In the embodiments, the predefined speed includes a first predefined speed for forward movement of the vehicle 100 in the walk assist mode, and a second predefined speed corresponding to a reverse movement of the vehicle 100 in the walk assist mode. The second predefined speed may be equal to or smaller than the first predefined speed.

To facilitate the rider to activate of the walk assist mode of the vehicle 100, the drive control system 140 includes at least button/switch/lever adapted to be depressed/displaced by the rider. In some embodiments, the least one switch includes the first switch 152 to activate the walk assist mode and moving the vehicle in the forward direction, and the second switch 154 to activate the walk assist mode and moving the vehicle 100 in the reverse direction. It may be appreciated the walk assist mode is activated to move the vehicle 100 in the forward direction when the first switch 152 is displaced to the depressed position and held at the depressed position for a predefined duration. Similarly, the walk assist mode is activated to move the vehicle 100 in the reverse direction when the second switch 154 is displaced to the depressed position and held at the depressed position for the predefined duration.

In some embodiments, the switch assembly 150 includes two separate switches/buttons, for example, a first button and a second button, to activate the walk assist mode and move the vehicle in the walk assist mode. The first button and the second button are different from the first button and the second button. A movement of the vehicle 100 in the forward direction in the walk assist mode is enabled upon depressing the first button, while the movement of the vehicle 100 in the reverse direction and in the walk assist mode is enabled when the second button is depressed. Similarly, the walk assist mode is disabled/deactivated upon depressing the first button or the second button again.

Moreover, referring to FIG. 2, the vehicle 100 is adapted to be operated in a hold mode in which the vehicle 100 is at rest till the hold mode is active. To activate the hold mode, the vehicle 100 may include a hold lever/switch 168 adapted to be displaced to a depressed position and a free position by a rider of the vehicle 100. To activate the hold mode, the hold lever 168 is moved to the depressed position and to deactivate the hold mode, the hold lever 168 is moved/arranged at the free position. In some embodiments, a parking brake of the vehicle 100 is actuated upon activation of the hold mode and the parking brake is released upon deactivation of the hold mode. In some embodiments, a power of the electric traction motor 142 is controlled to keep the vehicle 100 at rest when the hold mode is activated. It may be appreciated that the power of the electric traction motor is controlled so as to keep the vehicle 100 at rest when the throttle lever 164 is arranged at free position. In some embodiments, the drive control system 140 i.e., the vehicle 100 may be arranged at an inclination and the power of the electric traction motor 142 is controlled to keep the vehicle 100 at rest on the inclination. To facilitate such a control of the electric power of the electric traction motor 142, the vehicle 100 may include an inclination sensor 170 to determine an inclination of the path on which the vehicle 100 is moving or arranged. The rider may activate the hold mode on the inclination to facilitate a loading of the vehicle 100 on a truck from a ramp or the unloading of the vehicle 100 on the ramp from the truck.

To operate/control the vehicle 100 in various modes, the drive control system 140 includes a controller 172 arranged in communication with various components and systems of the vehicle. For example, the controller 172 is communicatively coupled to the first switch 152 and the second switch 154. The controller 172 may also be communicatively coupled to the throttle lever 164, the speed sensor 166, the electric traction motor 142, the inclination sensor 170, the hold lever 168, the electric energy storage unit 134, the third and fourth switches 156, 162, and any other electrical and electronic system of the vehicle 100. The controller 172 is adapted to control the at least one electric traction motor 142 based on input received from one or more of the switches 152, 154, 156, 162, the hold lever 168, the throttle lever 164, the inclination sensor 170, the speed sensor 166, etc. The controller 172 may control the at least one electric traction motor 142 based on predefined instructions/maps stored inside a memory 174 of the controller 172, and controls the operation of the vehicle 100. In an embodiment, the controller 172 is an electronic control module (ECM) of the vehicle 100.

The controller 172 includes a processor 176 and the memory 174 to respectively process and store the data received from the at least one sensor and other electrical and electronic component of the vehicle 100. In some embodiments, the instructions to process the data and/or control the various components of the vehicle 100, for example, the switches 152, 154, 156, 162, the throttle lever 164, the speed sensor 166, the hold lever 168, the inclination sensor 170, the at least one electric traction motor 142, the electrical energy storage unit 134, any other electrical or electronic component of the vehicle 100 is stored inside the memory 174 of the controller 172.

The memory 174 may be integrated into the controller 172, but those skilled in the art will understand that the memory 174 may be separate from the controller 172 but onboard the vehicle 100, and/or remote from the controller 172 and the vehicle 100, while still being associated with and accessible by the controller 172 to store information in and retrieve information from the memory 174 as necessary during the operation of the vehicle 100 i.e., the drive control system 140, the at least one electric traction motor 142, etc. Although the processor 176 is contemplated, it is also possible and contemplated to use other electronic components such as a microcontroller, an application specific integrated circuit (ASIC) chip, or any other integrated circuit device. The processor 176 is configured to execute specified instructions, which controls and monitors various functions associated with the drive control system 140, the at least one electric traction motor 142, and any other system or component of the vehicle 100, etc.

To activate the walk assist mode of the vehicle 100, the processor 176 is configured to determine the displacement of the first switch 152 or the second switch 154 to the depressed position and holding of the first switch 152 or the second switch 154 at the depressed position for the predetermined duration. It may be appreciated that the processor 176 activates the walk assist mode for the forward direction of movement of the vehicle 100 in response to the determination of the displacement of the first switch 152 to the depressed position and holding of the first switch 152 at the depressed position for the predetermined duration. Upon activation of the walk assist mode in the forward direction, the processor 176 controls the electric traction motor 142 at to operate the electric traction motor 142 at the reduced power relative to the operation of the electric traction motor 142 in the normal mode. In an embodiment, the processor 176 is configured to initiate the movement of the vehicle 100, in walk assist mode, in the forward direction i.e., rotate the electric traction motor 142 in the first direction, in response to the displacement of the throttle lever 164 from its free position. In such a case, in some embodiments, the processor 176 controls the electrical current provided to the electric traction motor 142 in proportion to the displacement of the throttle lever 142 from its free position such that the speed of the vehicle 100 remains equal to or below the first predefined speed when the throttle lever 164 is arranged at its maximum displaced position.

In some embodiments, the processor 176 is configured to control the electric current provided to the electric traction motor 142 such that a constant predetermined electric current is provided to the electric traction motor 142 to move the vehicle 100 at a constant first predefined speed irrespective of the displacement of the throttle lever 164 from its free position. It may be noted that the processor 176, in some embodiments, may deactivate the walk assist mode for the forward direction of the movement of the vehicle 100 in response to the displacement of the first switch 152 to the depressed position when the walk assist mode is active. Also, in some embodiments, the processor 176 may deactivate the walk assist mode of the vehicle 100 in response to the determination of the pressing of the neutral switch 156 to disengage the electric traction motor 142 from the rear wheels 114 or the start-stop switch 162 to stop the rotation of the electric traction motor 142.

Similarly, the processor 176 activates the walk assist mode for the reverse direction of movement of the vehicle 100 in response to the determination of the displacement of the second switch 154 to the depressed position and holding of the second switch 154 at the depressed position for the predetermined duration. Upon activation of the walk assist mode in the reverse direction, the processor 176 controls the electric traction motor 152 at the reduced power relative to the operation of the electric traction motor 142 in the normal mode. In an embodiment, the processor 176 is configured to initiate the movement of the vehicle 100, in walk assist mode, in the reverse direction i.e., rotate the electric traction motor 142 in the second direction, in response to the displacement of the throttle lever 164 from its free position. In such a case, in some embodiments, the processor 176 controls the electrical current provided to the electric traction motor 142 in proportion to the displacement of the throttle lever 164 from its free position such that the speed of the vehicle 100 remains equal to or below the second predefined speed when the throttle lever 164 is arranged at its maximum displaced position.

In some embodiments, the processor 176 is configured to control the electric current provided to the electric traction motor 142 such that a constant predetermined electric current is provided to the electric traction motor 142 to move the vehicle 100 at a constant second predefined speed irrespective of the displacement of the throttle lever 164 from its free position. It may be noted that the processor 176, in some embodiments, may deactivate the walk assist mode in the reverse direction of the movement of the vehicle 100 in response to the displacement of the second switch 154 to the depressed position when the walk assist mode is active. Also, in some embodiments, the processor 176 may deactivate the walk assist mode of the vehicle 100 in response to the determination of the pressing of the neutral switch 156 or the start-stop switch 164.

To activate the hold mode and to keep the vehicle 100 at rest, for example, on a ramp during loading of the vehicle 100 onto a truck or unloading the vehicle 100 from the truck, the processor 176 determines a depression of the hold lever 168 to the depressed position and activates the hold mode, and operates/controls the vehicle 100 in the hold mode. In some embodiments, the processor 176 is configured to activate the hold mode when the vehicle 100 is arranged on an inclination determined based on input from the inclination sensor 170. In an embodiment, in the hold mode, the processor 176 is configured to control the electric traction motor 142 to keep the vehicle at rest. For example, the processor 176 may, based on input from the speed sensor 166, may determine a downward movement/speed of the vehicle 100 on the inclination when the throttle lever 164 is arranged at its free position, and controls the electric traction motor 142, for example, controls the electric current provided to the electric traction motor 142 to rotate the electric traction motor 142 at a rotation speed to counter the downward speed of the vehicle 100 and keep the vehicle 100 at rest.

In some embodiments, instead of measuring the downward speed of the vehicle 100 on the ramp/inclination, the processor 176 may predict the downward speed of the vehicle 100 based on input received from the inclination sensor 170, and accordingly control the rotation of the electric traction motor 142 to keep the vehicle 100 at rest when the hold mode is activated. In some embodiments, the processor 176, in the hold mode, is configured to control the electric traction motor 142 based on input received from both the inclination sensor 170 and the speed sensor 166. For example, the processor 176 may initially predict a downward speed of the vehicle 100, when the throttle lever 164 is arranged at its free position, on the inclination based on the input from the inclination sensor 170, and accordingly control the electric traction motor 142 to counter the predicted downward speed. Subsequently, the processor 176 may determine a downward motion, if any, of the vehicle 100 on the ramp/inclination based on input from speed sensor 166, and controls the electric traction motor 142 to counter the downward motion of the vehicle 100 to keep the vehicle 100 at rest. In some embodiments, the processor 176, instead of controlling the electric traction motor 142, may apply parking brake to keep the vehicle 100 at rest in the hold mode. The processor 176 is configured to deactivate the hold mode upon displacement of the hold lever 168 to its default/free position. In some embodiments, the processor 176 may deactivate the hold mode of the vehicle 100 in response to the displacement of the throttle lever 164 from the free position when the hold mode is active.

In some embodiments, the processor 176 activates the hold mode when the hold lever 168 is displaced to the depressed position when the walk assist mode is active. In such a case, the processor 176 reactivate the walk assist mode and operates the vehicle 100 in the walk assist mode upon deactivation of the hold mode. However, in some embodiments, the processor 176 may activate the normal mode and operates the vehicle 100 in the normal mode upon deactivation of the hold mode. Similarly, the processor 176 may activate the hold mode when the vehicle 100 is operating in the normal mode.

The hold mode facilitates the rider to move the vehicle 100 from the ramp to the truck by positioning the vehicle 100 near the truck and on the ramp, and allowing the rider to remove his hands from the throttle lever 164 and the handlebar while keeping the vehicle 100 at rest on the ramp. Upon moving inside the truck, the rider may hold the handlebar pull the vehicle 100 inside the truck. Similarly, the hold mode facilitates a shifting of the vehicle 100 from the truck to the ramp while unloading the vehicle 100.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended the scope of the disclosure be defined by the claims appended hereto.

What is claimed is:

1. A drive control system for a saddle riding utility vehicle, the drive control system comprising:
at least one electric traction motor arranged to be rotated in a first direction and a second direction to move the saddle riding utility vehicle in a forward direction and a reverse direction;
a first switch configured to be displaced from a free position to a depressed position to activate a movement of the saddle riding utility vehicle in the forward direction;
a second switch adapted to be displaced from a free position to a depressed position to activate a movement of the saddle riding utility vehicle in the reverse direction; and
a controller communicatively coupled to the first switch, the second switch, and the at least one electric traction motor, the controller is configured to
activate a walk assist mode of the saddle riding utility vehicle in response to displacement of one of the first switch and the second switch to the depressed position and holding the displaced switch of the first switch and the second switch at the depressed position for a predetermined duration, and
control a power of the at least one electric traction motor to keep a speed of the saddle riding utility vehicle below a predefined speed when the walk assist mode is active.

2. The drive control system of claim 1, wherein the controller is configured to activate the walk assist mode for movement of the saddle riding utility vehicle in the forward direction when the first switch is displaced to the depressed position and held at the depressed position for the predetermined duration.

3. The drive control system of claim 1, wherein the controller is configured to activate the walk assist mode for movement of the saddle riding utility vehicle in the reverse direction when the second switch is displaced to the depressed position and held at the depressed position for the predetermined duration.

4. The drive control system of claim 1, wherein the controller is configured to
activate a hold mode of the saddle riding utility vehicle in response to the displacement of a hold lever to a depressed position, and
control the at least one electric traction motor to keep the saddle riding utility vehicle at rest upon activation of the hold mode.

5. The drive control system of claim 4, wherein the controller is configured to activate the hold mode in response to the displacement of the hold lever to the depressed position when the walk assist mode is active.

6. The drive control system of claim 4, wherein the controller is configured to activate the hold mode when the saddle riding utility vehicle is disposed at an inclination.

7. The drive control system of claim 6 further comprises an inclination sensor to monitor an angle of inclination and the controller is configured to control the at least one electric traction motor to keep the saddle riding utility vehicle at rest on the inclination when a throttle lever of the saddle riding utility vehicle is arranged at a free position.

8. The drive control system of claim 6, wherein the controller is configured to control the at least one electric traction motor based on a speed of the saddle riding utility vehicle in a downward direction on the inclination when a throttle lever of the saddle riding utility vehicle is arranged at a free position.

9. A saddle riding utility vehicle, comprising:
at least one electric traction motor arranged to be rotated in a first direction and a second direction to move the saddle riding utility vehicle in a forward direction and a reverse direction;
a first switch configured to be displaced from a free position to a depressed position to activate a movement of the saddle riding utility vehicle in the forward direction;
a second switch adapted to be displaced from a free position to a depressed position to activate a movement of the saddle riding utility vehicle in the reverse direction; and
a controller communicatively coupled to the first switch, the second switch, and the at least one electric traction motor, the controller is configured to
activate a walk assist mode of the saddle riding utility vehicle in response to displacement of one of the first switch and the second switch to the depressed position and holding the displaced switch of the first switch and the second switch at the depressed position for a predetermined duration, and
control a power of the at least one electric traction motor to keep a speed of the saddle riding utility vehicle below a predefined speed when the walk assist mode is active.

10. The saddle riding utility vehicle of claim 9, wherein the controller is configured to activate the walk assist mode for movement of the saddle riding utility vehicle in the forward direction when the first switch is displaced to the depressed position and held at the depressed position for the predetermined duration.

11. The saddle riding utility vehicle of claim 9, wherein the controller is configured to activate the walk assist mode for movement of the saddle riding utility vehicle in the reverse direction when the second switch is displaced to the depressed position and held at the depressed position for the predetermined duration.

12. The saddle riding utility vehicle of claim 9 further comprising
a hold lever adapted to be displaced between a free position and a depressed position, and the controller is configured to
activate a hold mode of the saddle riding utility vehicle in response to the displacement of the hold lever to the depressed position, and
control the at least one electric traction motor to keep the saddle riding utility vehicle at rest upon activation of the hold mode.

13. The saddle riding utility vehicle of claim 12, wherein the controller is configured to activate the hold mode in response to the displacement of the hold lever to the depressed position when the walk assist mode is active.

14. The saddle riding utility vehicle of claim 12, wherein the controller is configured to activate the hold mode when the saddle riding utility vehicle is disposed at an inclination.

15. The saddle riding utility vehicle of claim 14 further comprises an inclination sensor to monitor an angle of inclination and the controller is configured to control the at least one electric traction motor to keep the saddle riding utility vehicle at rest on the inclination when a throttle lever of the saddle riding utility vehicle is arranged at a free position.

16. The saddle riding utility vehicle of claim 14, wherein the controller is configured to control the at least one electric traction motor based on a speed of the saddle riding utility vehicle in a downward direction on the inclination when a throttle lever of the saddle riding utility vehicle is arranged at a free position.

17. A saddle riding utility vehicle, comprising:
at least one electric traction motor arranged to be rotated in a first direction and a second direction to move the saddle riding utility vehicle in a forward direction and a reverse direction;
a first switch configured to be displaced from a free position to a depressed position to activate a movement of the saddle riding utility vehicle in the forward direction;
a second switch adapted to be displaced from a free position to a depressed position to activate a movement of the saddle riding utility vehicle in the reverse direction; and
a controller communicatively coupled to the first switch, the second switch, and the at least one electric traction motor, the controller is configured to
activate a walk assist mode of the saddle riding utility vehicle in response to displacement of one of the first switch and the second switch to the depressed position and holding the displaced switch of the first switch and the second switch at the depressed position for a predetermined duration, and
control a power of the at least one electric traction motor to keep a speed of the saddle riding utility vehicle below a predefined speed when the walk assist mode is active, wherein
the controller is configured to activate the walk assist mode for movement of the saddle riding utility vehicle in the forward direction when the first switch is displaced to the depressed position and held at the depressed position for the predetermined duration, and
the controller is configured to activate the walk assist mode for movement of the saddle riding utility vehicle in the reverse direction when the second switch is displaced to the depressed position and held at the depressed position for the predetermined duration.

18. The saddle riding utility vehicle of claim 17 further comprising
a hold lever adapted to be displaced between a free position and a depressed position, and the controller is configured to
activate a hold mode of the saddle riding utility vehicle in response to the displacement of the hold lever to the depressed position, and
control the at least one electric traction motor to keep the saddle riding utility vehicle at rest upon activation of the hold mode.

19. The saddle riding utility vehicle of claim 18, wherein the controller is configured to activate the hold mode when the saddle riding utility vehicle is disposed at an inclination.

20. The saddle riding utility vehicle of claim 19 further comprises an inclination sensor to monitor an angle of inclination and the controller is configured to control the at least one electric traction motor to keep the saddle riding utility vehicle at rest on the inclination when a throttle lever of the saddle riding utility vehicle is arranged at a free position.
